(19) United States
(12) Patent Application Publication
(10) Pub. No.: US 2002/0004848 A1
(43) Pub. Date: Jan. 10, 2002

(54) System and method of providing an asynchronous interface between a client system and an enterprise javabeans-enabled server

(76) Inventors: Krishna Sudarshan, Cupertino, CA (US); Anurag Shekhar, Patna (IN); Moses Pachaipandian, Chennai (IN); Ramakrishnan Jayachandran, Chennai (IN); Skandarajah Maharajan, Chennai (IN)

Correspondence Address: Ketan S. Vakil, Sheppard, Mullin, Richter & Hampton LLP, 333 S. Hope Street, 48th Floor, Los Angeles, CA, 90071, US

(21) Appl. No.: 09/815,481

(22) Filed: Mar. 23, 2001

Related U.S. Application Data
(60) Provisional application No. 60/193,003, filed on Mar. 29, 2000.
(60) Provisional application No. 60/193,007, filed on Mar. 29, 2000.

(51) Int. Cl. G06F 9/00; G06F 9/54; G06F 15/163

(52) U.S. Cl. 709/310

(57) ABSTRACT

A method of implementing an interface to achieve asynchronous method invocations between a client system, a messaging server, and an enterprise JavaBeans-enabled server is provided which includes performing a lookup operation for an asynchronous home interface on JNDI directory service, returning a reference to the asynchronous home interface of an enterprise bean, to the client system, and making a call on the reference. The method also includes providing a listener for the asynchronous home interface to monitor a plurality of events, generating an event, receiving a result after generating the event; and executing a method of the listener.

### CROSS-REFERENCE TO RELATED APPLICATIONS

This application claims priority from U.S. provisional patent applications Ser. Nos. 60/193,003 and 60/193,007, both filed on Mar. 29, 2000, which are herein incorporated by reference for all purposes.

### FIELD OF THE INVENTION

The present invention relates generally to systems and methods for providing asynchronous and synchronous interfaces between a client system and an Enterprise JavaBeans (“EJB”)-enabled server. More particularly, the present invention relates to systems and methods for providing asynchronous method invocations between the client system and the EJB-enabled server without implementing any explicit messaging calls.

### BACKGROUND OF THE INVENTION

The EJB architecture, developed by Sun Microsystems, Inc., is a standard component architecture for building distributed object-oriented applications in the Java programming language. A distributed object-oriented application is an application program in which parts of the application program are located in different physical locations. The EJB architecture allows application developers to build these distributed applications by combining components that are developed by using tools from multiple vendors. This architecture defines the contracts that enable these tools to develop and deploy components that can inter-operate at runtime.

The EJB architecture utilizes an EJB specification that defines the functions and operations of the components of the EJB architecture. Components are pre-developed modules of application code that run in an application server and that can be assembled into working application systems. The EJB specification provides a framework for the development and deployment of components. These components may be plugged into the EJB-enabled server to enhance the EJB-enabled server's functionality. For example, the components provided by one vendor can be easily integrated with the components provided by other vendors using the EJB specification.

FIG. 1 is a simplified block diagram of an EJB architecture 10 having a client system 12 and an EJB-enabled server 14 and configured to perform synchronous method invocations. The server has a number of components including a number of containers 16 and a number of enterprise beans 18. The server provides the system level services such as load balancing, scalability, and interaction with an application server (not shown). The server is an EJB-enabled server that is configured to host the containers.

Enterprise beans 18 are components of the EJB architecture that are developed once and then deployed on multiple EJB-enabled servers without recompilation or source code modification. Enterprise beans reside in the container 16, encapsulate application logic, and contain logic functions that operate on data stored in the EJB-enabled server 14 and a database 20.

The EJB architecture defines two types of enterprise beans 18, session beans and entity beans. A key difference between session and entity beans is the fact that an entity bean has a persistent state while a session bean models interactions but does not have a persistent state. Entity beans are associated with objects and persistent records in some sort of database (Resource Manager). In contrast, session beans do not represent database records but rather, represent extensions of the client application and are responsible for managing processes or tasks. The client system 12 accesses the session bean through the session bean's remote interface. Each session bean is an EJB instance associated with a single client system and is typically non-persistent. An entity bean represents information persistently stored in the database 20 and is associated with database transactions. The persistence of entity beans is handled by the entity beans themselves or by the container 16. The entity beans that represent a business object can be shared among multiple client systems 12.

To implement a bean, two interfaces need to be defined: a home interface and a remote interface. The home interface defines the bean's life cycle methods including methods for creating new beans, removing beans and finding beans. The enterprise bean's home interface defines the methods for the client system 12 to create, remove, and locate EJB objects of the same type (i.e., they are implemented by the same enterprise bean). The client system can locate the enterprise bean's home interface through the Java Naming and Directory Interface (JNDI) API. The remote interface defines the bean's business methods callable by the client system, i.e., the methods a bean presents to the outside world to do its work. Each EJB object is accessible via the enterprise bean's remote interface.

Containers 16 reside in the server 14 and are responsible for managing the interactions between a bean and its server. Each container is responsible for presenting a uniform interface between the bean and the server, creating new instances of the bean, and providing services such as concurrency, locking, persistence management, remote access, and security, to the enterprise beans 18. Multiple enterprise beans can be installed in and deployed from the same container. The container also creates a class that implements the home interface of an enterprise bean. The container is responsible for making the home interfaces of its deployed enterprise beans available to the client system 12 through JNDI.

In the EJB-enabled server 14, the enterprise beans 18 are deployed into the containers 16. The deployment process, illustrated in FIG. 2, begins when the container generates implementations of the home interface and the remote interface of the enterprise beans for use at runtime (step S-1). These implementations are then compiled to use remote method invocation (RMI) or any other such synchronous protocols as the protocol of communication with the EJB-enabled server (step S-2). . The RMI protocol uses stubs and skeletons for communication between the client side and server side components. The skeletons 15 are generated classes that are located on the server side and stubs 13 are generated classes that are located on the client side (step S-3) (see also FIG. 3). Referring to FIG. 3, stubs 13 and skeletons 15 are responsible for making the method calls on the server 14 appear as if they were running locally on the client system 12. The stub 13 resides on the client system and is connected to the skeleton 15 via a network. The skeleton 15 is set up on a port at the EJB-enabled server side and listens for requests from the stub 13. When an object makes a method call on any home or remote interface of a bean, the control transfers from the calling object to the called object's stub. When the client system 12 invokes the method on the stub 13, the name of the method invoked and the values passed in as parameters are communicated to the skeleton 15. For example, in FIG. 3, the method invokes a create routine. The skeleton parses the incoming stream to properly invoke the method and the result is streamed back to the stub.

The EJB specification also defines the client-view contract (or client contract) and component contract. The client-view contract is the contract between the client and a container and provides a uniform development model for applications using enterprise beans as components. The client view contract of the enterprise bean includes home interface, remote interface, object identity, metadata interface, and handle. The component contract defines the contract between the enterprise bean and its container.

The EJB specification also defines various other aspects of the EJB architecture, e.g., the roles played by the various users and the runtime attributes of an enterprise bean called the Deployment Descriptor. In addition, the EJB specification supports various protocols including RMI and Internet Inter-Orb Protocol (IIOP). RMI is typically the default protocol that is supported by the EJB specification. RMI is the basis of distributed object systems and is responsible for making the distributed objects' location transparent, i.e., the object's location is unknown and unimportant to the client system 12.

Using the RMI protocol, the EJB specification defines a synchronous mode of communication between the client system 12 and the server 14. Synchronous communication means that when a request is made from one object to another, the calling object will be blocked until it obtains a response from the called object. For example, when the client system makes a request, e.g., a method call, to the server, the client system making the call is blocked for the duration of the call and until a response is received (see FIG. 1). That is, the client system will be blocked until the request is communicated to the server, the request is processed by the server, and a result is returned to the client system or an exception occurs. One drawback of synchronous communication is that the client system is unable to process further requests from the user application until and unless the server has completed the previous request. This strictly sequential processing may not be necessary or appropriate for a number of applications. For instance if a client system is sending updates to a remote server and does not care about a reply from the server, and only expects the updates to reach the server reliably, a strictly synchronous behavior is not required and such applications are better served by an asynchronous model. In this case, the client system simply queues up updates and as long as is guaranteed reliable delivery to the server, is free to process other requests before even hearing back from the server.

As a result of the problems associated with synchronous communication and the need for asynchronous communication in a distributed environment, EJB-enabled servers 14 have been developed which provide asynchronous capabilities. Current EJB-enabled servers achieve asynchronous capability at the application level by implementing an EJB-Java Messaging Service (JMS) bridge 19 on the EJB-enabled server (see FIG. 4). One drawback of the EJB-JMS implementation is that the client system has to make JMS messaging calls that the EJB-enabled server understands and executes.

It should therefore be appreciated that there is a need for asynchronous communication protocols at the container level to create a reliable, scalable, and configurable messaging engine infrastructure where there is no loss of time or data due to non-availability of resources. Also, it should be appreciated that there is a need to extend the messaging capabilities to support asynchronous communications in a multi-tier distributed EJB environment where the programmer does not have to write any explicit messaging calls. The present invention fulfills these needs as well as others.

### SUMMARY OF THE INVENTION

The present invention modifies the client contract to allow existing EJB technology to accommodate asynchronous method invocations. The client contract specifies the way a client system communicates with an EJB-enabled server. The client system can use any protocol to communicate with the EJB-enabled server. The component contract specifies the way server-side components communicate with each other where RMI is the default protocol for these communications. The present invention is directed to an efficient and safe way of implementing an interface for asynchronous communication into the EJB specification by modifying the client contract.

A method of implementing an interface to achieve asynchronous method invocations between a client system, a messaging server, and an enterprise JavaBeans-enabled server is provided which includes performing a lookup operation for an asynchronous home interface on JNDI directory service, returning a reference to the asynchronous home interface of an enterprise bean, to the client system, and making a call on the reference. The method also includes providing a listener for the asynchronous home interface to monitor a plurality of events, generating an event, receiving a result after generating the event; and executing a method of the listener.

One objective of the present invention is to provide an asynchronous interface between the client system and the EJB-enabled server, where asynchronous capability exists at the container level (as opposed to the application level), thereby protecting transactional integrity. In addition, the present invention provides for an asynchronous interface in which explicit messaging calls are not necessary.

Another objective of the present invention is enhancement of the EJB standard to create a new paradigm for application development in a multi-tiered distributed computing environment. Furthermore, the present invention provides a user on the client system with the capability to continuously work and process requests without experiencing server delays.

It is a further objective of the present invention to provide an interface, which helps create a reliable, scalable and configurable messaging engine infrastructure. This allows for the seamless and transparent queuing and delivery of messages. In addition, transactional queues are supported should guaranteed delivery be required.

It is yet a further objective of the present invention that little to no changes to EJBs are required in order to implement the asynchronous interface of the present invention. At deployment time the decision is made as to which protocol is appropriate for the EJB and the protocol can be modified with no reprogramming.

In addition, implementing the interface of the present invention allows existing applications to continue working while method calls are processed. The asynchronous form of method invocations provides fail-safe communication. Further, combining EJB with asynchronous method invocations allows for more flexibility and reliability to design applications.

It is yet another objective of the present invention that the interface of the present invention can be used to facilitate synchronous method invocations, asynchronous method invocations or both simultaneously, on an EJB.

Other features and advantages of the present invention should become apparent from the following description of the preferred embodiment, taken in conjunction with the accompanying drawings, which illustrate, by way of example, the principles of the present invention.

### BRIEF DESCRIPTION OF THE DRAWINGS

FIG. 1 is a simplified block diagram of a prior art EJB architecture having a client system and an EJB-enabled server, all configured to communicate synchronously;

FIG. 2 is a simplified flow chart illustrating the deployment process of enterprise beans into a container using the prior art EJB architecture of FIG. 1;

FIG. 3 is a simplified block diagram of a prior art EJB architecture, having a client system and an EJB-enabled server, that uses stubs and skeletons to communicate synchronously;

FIG. 4 is a simplified block diagram of a prior art EJB architecture having a client system and an EJB-enabled server and configured to communicate asynchronously at the application level;

FIG. 5 is a simplified block diagram of an EJB architecture having an EJB-enabled server, a client system and a messaging server, as used in an embodiment of the present invention;

FIG. 6 is a simplified block diagram of the client system and the EJB-enabled server of FIG. 5 where a container is illustrated as providing the interface that facilitates synchronous and asynchronous messaging; and

FIG. 7 is a simplified flow chart describing a method of developing a client side implementation of the interface of the present invention to achieve asynchronous method invocations in an EJB-enabled server.

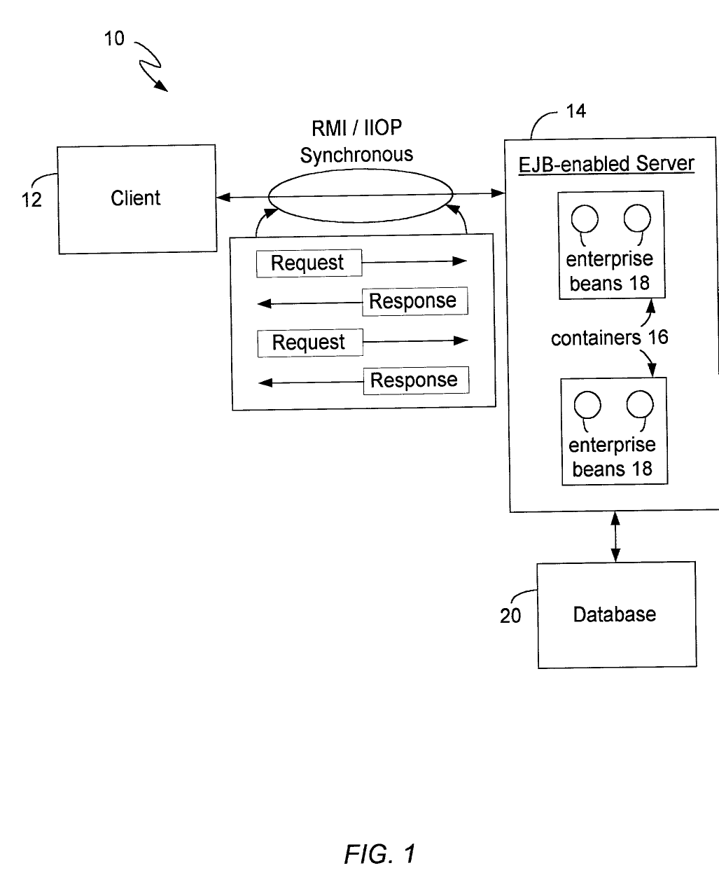

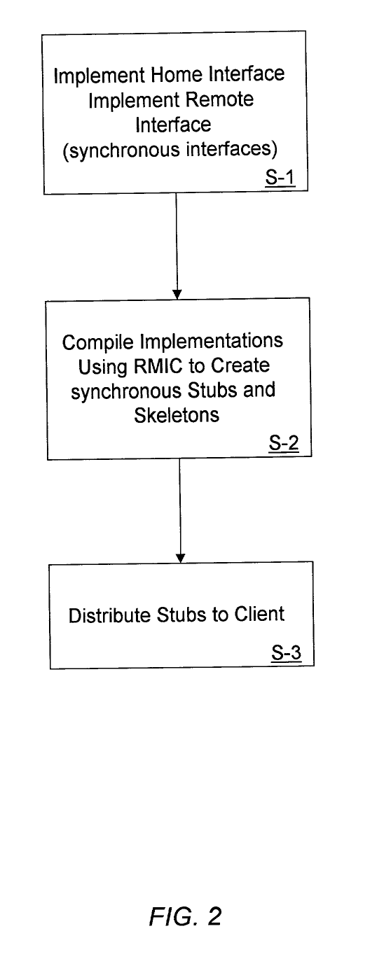

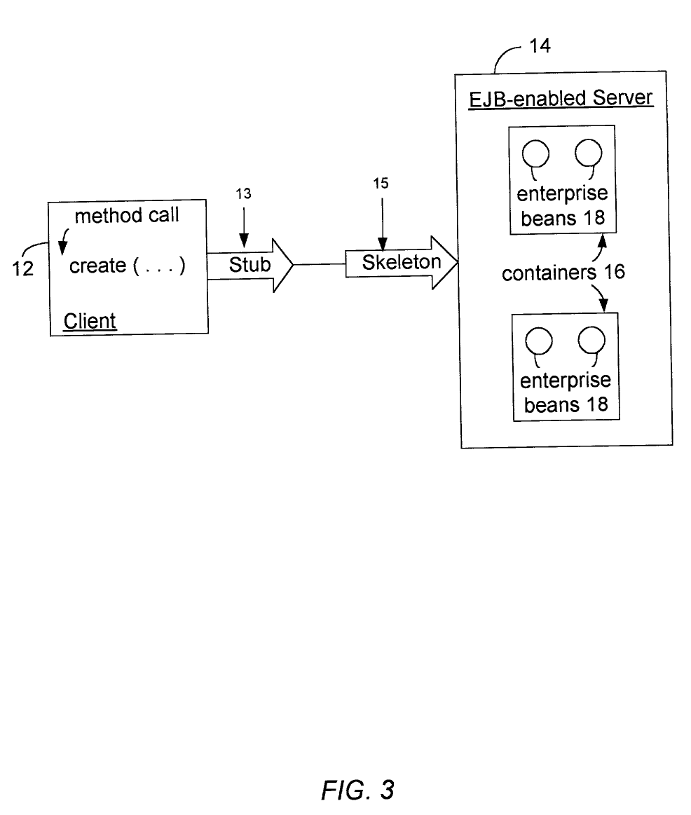

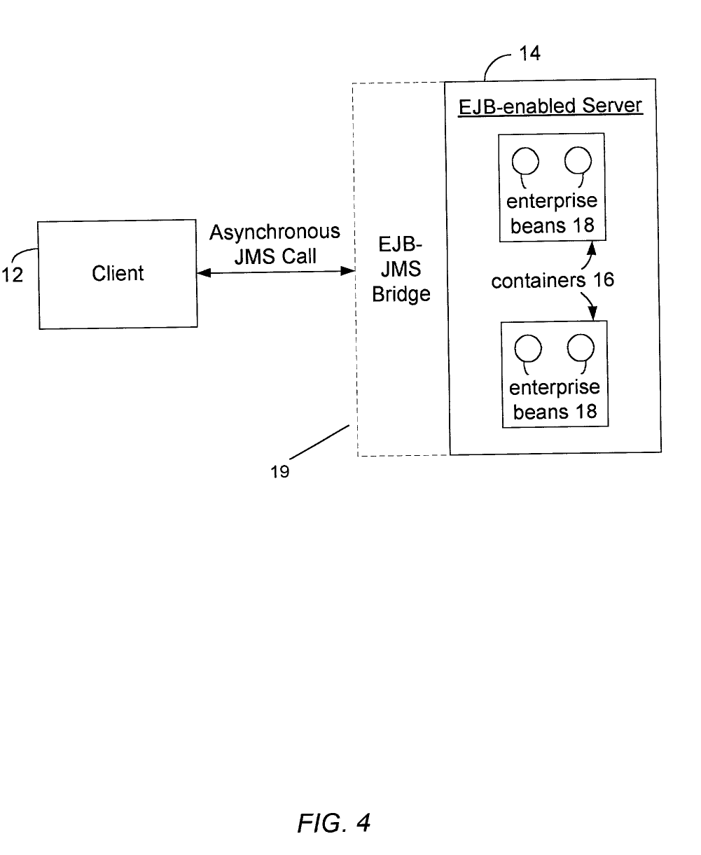

### DETAILED DESCRIPTION OF THE PREFERRED EMBODIMENT

The present invention expands on the EJB synchronous method invocation paradigm defined in the EJB specification to create an interface for implementing asynchronous method invocations to provide a scalable, reliable and configurable infrastructure to integrate distributed and diverse applications, without generating dependencies on messaging services or platforms. This combination of standards compliance and customizability is one feature of the present invention. The present invention also allows the communication protocol's access to an enterprise bean to be completely transparent to the client system. In various embodiments, the present invention enables synchronous method invocations, asynchronous method invocations or both simultaneously on an enterprise java bean.

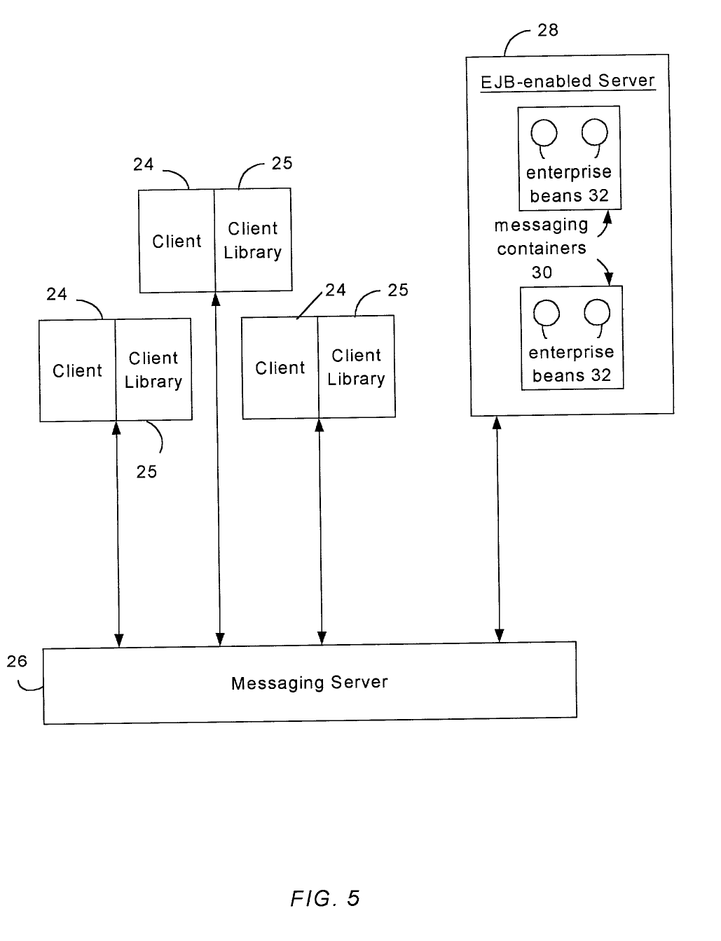

With reference to FIG. 5, there is shown an EJB architecture 22 having a client system 24, a messaging server (interchangeably referred to herein as messaging service) 26, and an EJB-enabled server 28 having a messaging engine and configured to provide asynchronous messaging at the container level using the messaging engine. The client system includes a client library 25 that is used to route messages from the client system to the messaging server and the EJB-enabled server. The client library may also be part of the messaging engine. The client system accesses the bean through the messaging server 26 using a method call provided by the client library. The messaging server 26 provides guaranteed message delivery. Examples of messaging servers 26 include IBM's MQ server and Oracle's AQ server. The EJB architecture may be implemented using one or more client systems, messaging servers, and EJB-enabled servers. This EJB architecture or any other architecture may be used to implement the asynchronous interface of the present invention. The interface can be implemented using hardware, software, or a combination of the two. For example, the interface can be the hardware that provides asynchronous communication between the client system and the messaging server and the messaging server and the EJB-enabled server. Also, the interface can be the software that is used to provide asynchronous communication between the client system and the messaging server and the messaging server and the EJB-enabled server.

The interface of the present invention enables the client system to listen to messaging events and be notified when they occur, and therefore, the client system is informed when the result arrives. The result that the client system receives is in the form of a VandaMessagingEvent object and the results can be obtained from this object. The interface can be used to plug into any commercially available messaging server 16 (e.g., Oracle AQ, IBM MQ Series, etc.), including any JMS implementation. One feature of the present invention is that the asynchronous client interface is generic in the sense that the client contract hides the messaging calls so that the application programmer does not have to explicitly code them. This allows a program to be written in a general manner while the specifics of any particular asynchronous communication protocol are handled by choosing an asynchronous data link layer at the time of deployment. The interface also modifies the client contract defined in the EJB specification in a way such that normal applications (which are written in a manner compliant with the EJB specification) are not affected by the interface.

The EJB specification provides for data link-specific containers that do not allow for a generic interface. As a consequence, asynchronous capability may only be provided at the application level (where transactional integrity is lost), not the container level (as in the present invention). The present invention ensures that the client system does not make any explicit messaging calls like the normal EJB-JMS implementation.

The interface of the present invention helps facilitate asynchronous method invocations so that by the pooling of requests or the transmission of the requests to a remote location, the client system is available to process additional requests from users without the current application incurring server delays. Asynchronous communication is achieved by modifying the client contract to accommodate asynchronous method invocation. The client contract is modified so that the messaging container does not become incompatible with conventional client systems using the default EJB method invocation mechanism.

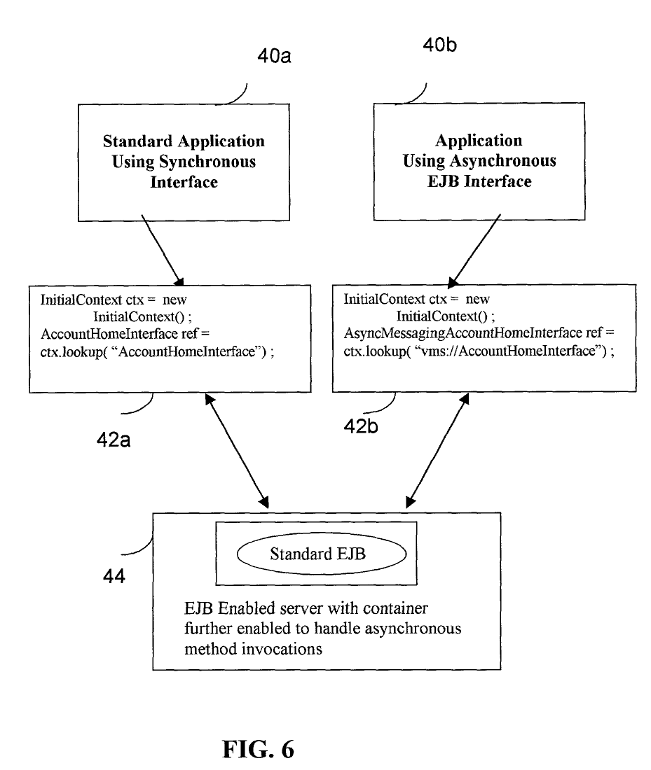

FIG. 6 is a simplified block diagram of the interface between the client system and the EJB-enabled server of FIG. 5 wherewith a container is illustrated as providing the interface that facilitates synchronous and asynchronous method invocations simultaneously. A standard EJB application 40a can obtain a normal home interface reference through JNDI 42a. Whereas an application that requires asynchronous behavior 40b can request an asynchronous home interface via JNDI 42b. The two applications can respectively, simultaneously invoke methods synchronously and asynchronously on the same enterprise java bean deployed in the container enabled to handle asynchronous method invocations 44.

Interface Specification

The following sections describe a method of developing an interface to achieve asynchronous method invocations between the client system and any EJB-enabled server without explicitly making any messaging-specific calls. The following sections are divided up as follows:

1. Client-side implementation;

2. Bean-side implementation;

3. API Reference; and

4. Example.

1. Client-side implementation

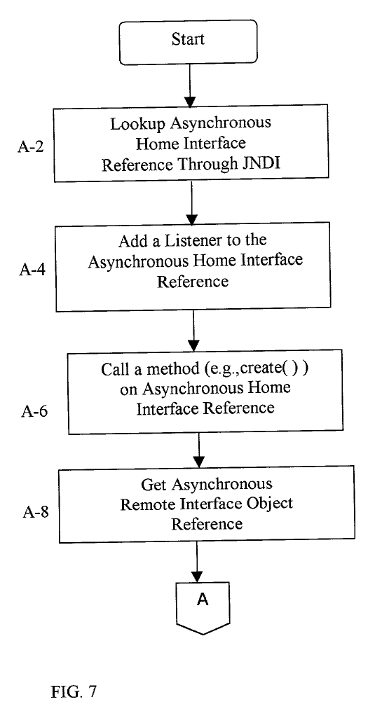

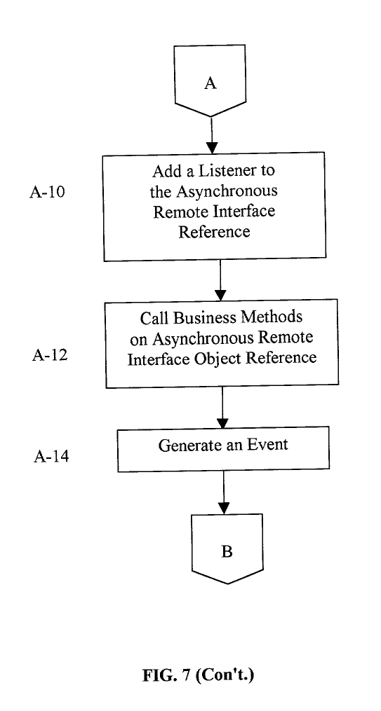

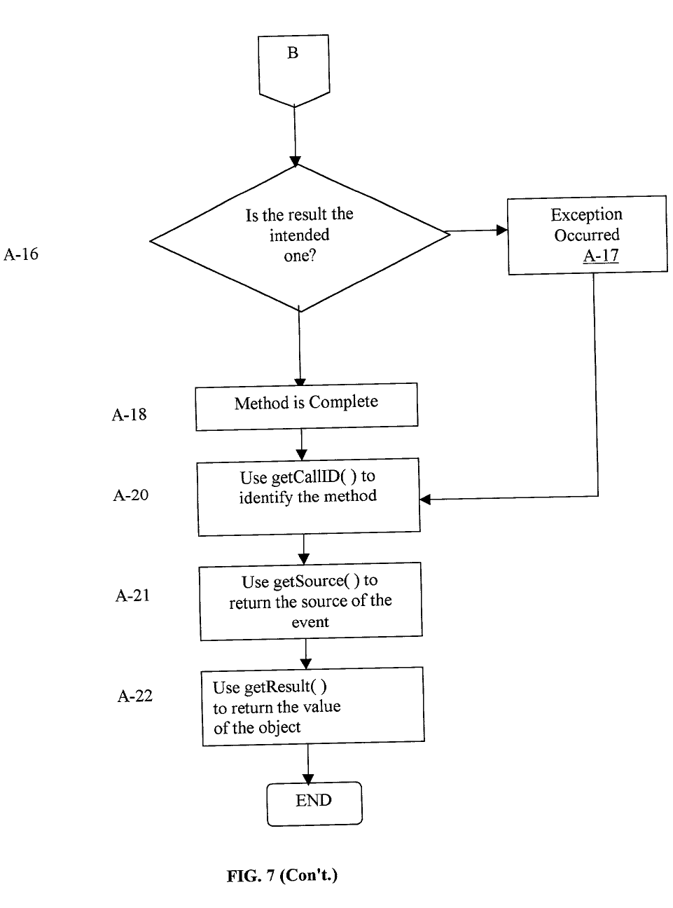

The following description refers to FIG. 7, which is a simplified flow chart describing a method of developing a client side implementation of the interface of the present invention to achieve asynchronous method invocations in an EJB-enabled server. Since the present invention deals with asynchronous method calls, the result is not returned immediately, and therefore, the EJB architecture uses a mechanism, e.g., a listener, by which a notification is generated and acknowledged when a result arrives. Events from asynchronous remote method invocations are triggered, i.e., fire, when the result arrives. That is, when the result arrives, an event is generated. One or more listeners (mechanisms for receiving an event or result from a previous remote method call) can register to be notified about the events. Event handlers can be instances of any class. As long as the class implements a VandaMessagingEventListener interface, its instances can handle events.

To invoke a remote bean's method asynchronously 1. Call Lookup Asynchronous Home Interface Reference on JNDI (Java Naming and Directory Interface) initial context with VMS as the protocol name (step A-2). 2. Add a listener to the Asynchronous Home Interface Reference returned by the Lookup (step A-4). 3. Call a method on the Asynchronous Home Interface Reference, which returns a CallID (step A-6). 4. Store the CallID returned by the method.

To receive and process the response 1. After the above method is executed, the methodCompleted( ) method is executed and if an exception is returned then the exception( )Occurred( ) method is executed. 2. These methods use a CallID (available from event.getCallID()) to identify the call which was completed. 3. These methods use a getResult( ) method to get the result for the call (e.g., if it is a create( ) method of Home), getResult( ) will return Messaging<<Bean>>Remotelnterface. This result is used by the client system for subsequent operations (step A-8).

As the present invention deals with asynchronous calls, the result is not returned immediately and therefore it is important to monitor when the result of a call is returned. One way to do this is to monitor for events. When the result arrives, an event is generated. One or more listeners can register to be notified about events. This also allows the programmer to delegate authority for event handling to the client library, which may be part of the client system 24, as opposed to having the programmer query for the results.

The business method used to implement the call lookup on the JNDI is described below.

A. Call Lookup on JNDI

To implement the call lookup, the client system calls lookup on the JNDI InitialContext with “VMS”0 (used in this example to signify asynchronous) as the protocol name. For example, if the client system is looking for the Home Interface of an Account Bean, the client code might be as follows (see also FIG. 6):

Context ctx = new InitialContext ( );
AsyncMessagingAccountHomeInterface ref =
ctx.lookup(“vms://AccountHomeInterface”);

In this example, the lookup returns an AsyncMessagingAccountHomelnterface to enable the client system to obtain a reference to the asynchronous home interface of the respective bean. This reference enables the client system to make asynchronous calls on the bean without having a user write any messaging calls. The asynchronous home interface is automatically generated during deployment and configuration of the enterprise bean. An example of the actual bean interface and the generated asynchronous home interface is shown below:

Actual Remote Interface of a StudentBean

import javax.ejb.*;
import java.rmi.*;
import java.util.*;
public interface StudentEntityCMPRemoteInterface extends

javax.ejb.EJBObject {

// All business methods of Remote Interface

public String computeGrade( ) throws RemoteException;
public int getId( ) throws RemoteException;
public void setId(int id) throws RemoteException;
public String getName( ) throws RemoteException;
public int getMarks( ) throws RemoteException,
public void setName(String name) throws RemoteException;
public void setMarks(int marks) throws RemoteException;
public void swapRecords(int recordId) throws RemoteException;
public void removeAndUpdateRecord(int recordId) throws

RemoteException;

public void removeRecord(int recordId) throws RemoteException,
public void updateRecord(int recordId) throws RemoteException;
public String getCallerName( ) throws RemoteException;
public boolean getRollback( ) throws RemoteException;
public void setRollback( ) throws RemoteException;
public void createRecs( ) throws RemoteException;

}

The following code represents the corresponding generated asynchronous home interface:

import java.util.*;
import java.rmi.*;
import java.security.*;
import vanda.generic.client.*;
import vanda.client.messaging.*;
import javax.ejb.*;
public interface AsyncStudentEntityCMPRemoteInterface
{
// All business methods ...

public long getName( ) throws java.rmi.RemoteException;
public long setName(java.lang.String param0) throws

java.rmi.RemoteException;

public long removeRecord(int param0) throws

java.rmi.RemoteException;

public long computeGrade( ) throws java.rmi.RemoteException;
public long createRecs( ) throws java.rmi.RemoteException;
public long getCallerName( ) throws java.rmi.RemoteException;
public long getId( ) throws java.rmi.RemoteException;
public long getMarks( ) throws java.rmi.RemoteException;
public long getRollback( ) throws java.rmi.RemoteException;
public long isCallerInRole(java.lang.String param0) throws

java.rmi.RemoteException;

public long removeAndUpdateRecord(int param0) throws

java.rmi.RemoteException;

public long setId(int param0) throws java.rmi.RemoteException;
public long setMarks(int param0) throws java.rmi.RemoteException;
public long setRollback( ) throws java.rmi.RemoteException;
public long swapRecords(int param0) throws

java.rmi.RemoteException;

public long updateRecord(int param0) throws

java.rmi.RemoteException;

// Other Utility business methods given as a part of the client interface

public Object getResult(long callId) throws Exception;
public boolean getStatus(long callId) throws

VandaResultAlreadyReceivedException

public void releaseMessagingService( );

// all Other EJB business methods - Given an Async Look

public long getHandle( ) throws RemoteException;
public long remove( ) throws RemoteException;
public void addListener(VandaMessagingEventListener e);
public VandaMessagingStub getEJBHome( );
public Object getPrimaryKey( );
public boolean isIdentical(Object obj);

}

For the above generated asynchronous remote interface, all the business methods are configured to return a long value to differentiate the asynchronous interface for each client system. When the client system invokes the methods, the methods return a long value called a CallID. The CallID is used by the client system when results arrive, to identify the appropriate method called. When implementing a synchronous call, the result returned is the actual value (or error exception); however, when implementing an asynchronous call, the result returned is not the actual value but rather an identifier (such as a CallID or other unique identifier), which can be used to retrieve the actual value returned from the asynchronous call.

Implementations of the present invention to achieve asynchronous method invocations, cause the calls made on the reference to be converted to messaging calls by the client library thereby hiding the messaging calls that would normally have to be made by the programmer. The reference given to the client systems are used to instantiate and generate asynchronous stubs. An example of the code used to instantiate and generate the asynchronous stubs is shown below.

import java.lang.*;
import java.util.*;
import java.sql.*;
import java.rmi.*;
import java.security.*;
import java.io.*;
import javax.ejb.*;
import vanda.generic.client.*;
import vanda.client.messaging.*;
import vanda.generic.messaging.*;
import vanda.generic.container.core.*;
import vanda.generic.server.core.*;
public class AsyncVandaStudentEntityCMPRemoteInterface

Impl_Stub

extends VandaMessagingStub
implements AsyncStudentEntityCMPRemoteInterface ,

Serializable

{

public AsyncVandaStudentEntityCMPRemoteInterface

Impl_Stub( )

{
setClassName(“StudentEntityCMPRemoteInterface”);
setIsSession(false);

}
public long getName( ) throws java.rmi.RemoteException
{

VandaMessagingAPIInterface vandaAPI = getVandaMessaging

API( );

VandaMessagingArgument vandaMesgArgs;
long methodCallId;
vandaMesgArgs = new VandaMessagingArgument( );
vandaMesgArgs.setClassName(“StudentEntityCMPRemote

Interface”);

vandaMesgArgs.setMethodName(“getName”);
if (VandaMessagingClient.isJavaClient( ) = = false)
{
vandaMesgArgs.setSessionId(VandaMessagingClient.getSession

Id( ));

}

vandaMesgArgs.setCallId(methodCallId =

VandaMessagingClient.getCallId( ));

vandaMesgArgs.setSecurityId(getSecurityId( ));
vandaMesgArgs.setTransactionContext(getTransaction

Context( ));

vandaMesgArgs.setRemoteObjectId(getObjectId( ));
vandaMesgArgs.setClientId(getClientId( ));
vandaMesgArgs.setConsumerName(getConsumerName( ));

vandaMesgArgs.setObjectType(

VandaMessagingObjectType.EJB_OBJECT);
vandaMesgArgs.setTargetMessagingDescriptor(

getTargetMessagingDescriptor( ));

registerMethodCall(vandaMesgArgs);
invokeMethod(vandaMesgArgs, “StudentEntityCMP”);
return( methodCallId);

}

.........
// Similarly as the above business method, all other business methods are

also implemented

}

As shown in the above code, the stub layer does not contain any direct messaging calls, rather, messaging objects are used for inserting messages into and retrieving messages from the messaging service 26 (see also FIG. 5). This plug-in implementation (or plug-in module) is a component of the EJB-enabled server and is dependent on the underlying messaging server 26. Each method described above builds a Messaging Argument object that contains details about the bean, the method to be called on that bean, parameters, their types, etc. The Messaging Argument object is used at the server side to call the correct method. After building this object, the request object is registered with the client library for event notification.

After the object is built, the stub calls invokeMethod which performs one or more of the following:

1. Enqueue the message into the messaging server 26 using the plug in module; or

2. Call the method directly if the client system is another bean and the target bean is also available at the same server.

The following is a generic interface that may be implemented to develop plug-in modules, which are messaging server dependent. The generic asynchronous stubs can use an implementation of the interface (described below) for inserting messages into and retrieving messages from the messaging server 26.

package vanda.generic.messaging;
import vanda.server.core.*;
public interface VandaMessagingAPIInterface
{

public void setMessagingDescriptor(VandaMessagingDescriptor

Interface mesgDesc);

public VandaMessagingDescriptorInterface getMessaging

Descriptor( );

public void setproxyMessagingDescriptor(

VandaProxyMessagingDescriptorInterface mesgDesc);

public VandaProxyMessagingDescriptorInterface

getProxyMessagingDescriptor( );

public boolean isClientProxy( );
public void enqueue (Object data) throws VandaMessagingEnqueue

Exception;

public void enqueue (Object data, String consumerName)

throws VandaMessagingEnqueueException;

public Object dequeue( ) throws VandaMessagingDequeueException;
public Object dequeue(String consumerName)

throws VandaMessagingDequeueException;

public Object dequeueNoWait( ) throws VandaMessagingDequeue

Exception;

public Object dequeueNoWait(String consumerName)

throws VandaMessagingDequeueException;

public void enqueue (Object data, String consumerName,

VandaMessagingDescriptorInterface mesgDesc)
throws VandaMessagingEnqueueException;

public Object browse( ) throws VandaMessagingOperationNot

AllowedException;

public void setSendTimeout(int timeout) throws

VandaMessagingOperationNotAllowedException;

public void setReceiveTimeout(int timeout) throws

VandaMessagingOperationNotAllowedException;

public boolean isMessageTimeoutSupported ( );
public boolean isReceiveTimeoutSupported ( );
public boolean isBrowseSupported ( );
public int getSendTimeout( ) throws

VandaMessagingOperationNotAllowedException;

public int getReceiveTimeout( ) throws

VandaMessagingOperationNotAllowedException;

public void releaseMessagingService( );

}

The above code refers to an object called Messaging Descriptor, which is a generic object that contains details about the messaging server 26. Details like topic name, queue name, etc. can be stored into this object. This object is kept opaque at the listener level for purposes of generality, but are interpreted at the messaging service 26 plug-in.

The following code is a sample implementation of the plug in module using JMS messaging calls and a publish subscribe method for communication:

public class VandaMessagingJMSImplementation

implements VandaMessagingAPIInterface {

.............
public void setMessagingDescriptor (VandaMessagingDescriptor

Interface mesgDesc)

{

mesgDescriptor = mesgDesc;

topicConnectionFactory =
new com.sun.messaging.TopicConnectionFactory

(jmsAddress,

mesgDescriptor.getPortNumber( ));

topicConnection=

topicConnectionFactory.createTopicConnection(mesgDescriptor.
getUserID( ),mesgDescriptor.getPassword( ));

topicConnection.start( );
topicSessionEnqueue = topicConnection.createTopicSession

(false,1);

topicSessionDequeue = topicConnection.createTopicSession

(false,1);

}
public VandaMessagingDescriptorInterface getMessagingDescriptor

( ){

return mesgDescriptor;

}
public void enqueue (Object data) throws VandaMessagingEnqueue

Exception{

String topicName;
String consumerName;
consumerName = mesgDescriptor.getConsumerName( );
topicName = mesgDescriptor.getTopicName( );
topic = topicSessionEnqueue.createTopic(topicName);
topicPublisher = topicSessionEnqueue.createPublisher(topic);
objMessage = topicSessionEnqueue.createObjectMessage( );
enqueueflag=true;
objMessage.setObject((Serializable)data);
objMessage.setStringProperty(“ConsumerName”,

consumerName);

topicPublisher.publish(objMessage);

}
/**
* enqueue(Object data ,String consumerName) puts the Message

Object into the messaging service with the

* details got from the messaging descriptor and the consumerName.
*/
public void enqueue (Object data, String consumerName) throws

VandaMessagingEnqueueException{

String topicName;
topicName = mesgDescriptor.getTopicName( );
topic = topicSessionEnqueue.createTopic(topicName);
topicPublisher = topicSessionEnqueue.createPublisher(topic);
objMessage = topicSessionEnqueue.createObjectMessage( );
enqueueflag=true;
objMessage.setObject((Serializable)data);
objMessage.setStringProperty(“ConsumerName”,

consumerName);

topicPublisher.publish(objMessage);

}
public Object dequeue( ) throws VandaMessagingDequeueException{

String topicName;
String consumerName;
topicName = mesgDescriptor.getTopicName( );
consumerName = mesgDescriptor.getConsumerName( );
topic = topicSessionDequeue.createTopic(topicName);
topicSubscriber = topicSessionDequeue.createSubscriber(topic,

“ConsumerName = “+ consumerName +”” false);

ObjectMessage objMessage = (ObjectMessage)topicSubscriber.

receive( );

return objMessage.getObject( );

}
public Object browse( ) throws VandaMessagingOperationNot

AllowedException {

throw new VandaMessagingOperationNotAllowedException

(“G003”);

}
public boolean isMessageTimeoutSupported ( ){

return false;

}
public boolean isReceiveTimeoutSupported ( ){

return false;

}
public boolean isBrowseSupported ( ){

return false;

}
public void releaseMessagingService( ){

topicPublisher.close( );
topicSubscriber.close( );
topicSessionEnqueue.close( );
topicSessionDequeue.close( );
topicConnection.close( );
topicConnectionFactory = null;

| } | |
|---|---|
| ...................... | |
| TopicConnectionFactory | topicConnectionFactory; |
| TopicConnection | topicConnection; |

| | |
|---|---|
| TopicSession | topicSession; |

| | |
|---|---|
| TopicPublisher | topicPublisher; |
| TopicSubscriber | topicSubscriber; |

| | |
|---|---|
| Topic | topic; |

VandaMessagingDescriptorInterface mesgDescriptor;
................

}

The business method used to add a listener is described below.

B. Adding a Messaging Event Listener

Event handlers can be instances of any class. To be an event handler, a class has to implement the VandaMessagingEventListener interface. By doing so, the instances of the class can handle events. The user needs to add a listener to the home interface reference retrieved as a result of the lookup operation or on a remote interface retrieved as a result of any operation performed on the home interface (step A-10). An example of the code for adding a listener is as follows:

ref.addListener (listener);

where ref is the home interface or remote interface reference and listener is the instance of any class which implements VandaMessagingEventListener. For example, it may be an instance of Listenerlmpl.

public class ListenerImpl implements VandaMessagingEventListener
{

public void methodCompleted(VandaMessagingEvent resEvent)
{

resEvent.getResult( ); //will return the result

}
public void exceptionOccurred(VandaMessagingEvent resEvent)
{

// handle the exceptions

}

}

Listeners enable the client system to receive the results of any call without having to query for them. In a normal asynchronous scenario, the client system would have to query for the result of an asynchronous call during the time when the result is unknown. In the case of listeners, the user is able to obtain the result and process it without having to write code to query for the result.

The business method used to call a method on the bean is described below.

C. Calling a Method on the Bean

In the case of an asynchronous call to the enterprise bean, the call to any method on the reference might not be different from a normal invocation except that the return value for the asynchronous call might be different. For example, when the create() method is called on an enterprise bean's MessagingHomeInterface, a unique CallID is returned as opposed to the normal return value of a RemoteInterface (step A- 12). The code for the call is as follows:

long createCallId=ref.create(....);

where createCallld is the variable in which the CallID is stored and ref represents the home interface reference. This is done since asynchronous methods do not return a value immediately. In order to be able to identify the call at a later time, the call returns a unique ID. The client program can then use this ID to identify the result when it arrives.

D. Receiving and Processing the Result

Once an event has been generated (step A-14), the result in the case of an asynchronous invocation of a bean can return either the intended return value or an exception (step A-16). If the method invocation is successful, the methodCompleted( ) method of the listener is executed (A- 18) and if an exception occurred (step A- 17), the exceptionOccurred( ) method of the listener is executed. In the methodCompleted( ) method and the exceptionOccurred( ) method, the VandaMessagingEvent is passed as a parameter.

The VandaMessagingEvent class has the following three methods:

[a] getCallID() (step A-20)

This method returns the CallID that was generated when the client application called a particular method on the MessagingHomeInterface of the bean. This can be compared with the ID stored at the time of the bean method invocation to identify the call that generated this result.

[b] getsource( ) (step A-21)

This method returns the source of the event. For example, if the user had called the create( ) method on the MessagingAccountHomelnterface, this may return a string containing MessagingAccountHomelnterface:create. This string contains the name of the interface that contained the bean method called and the method name itself

[c] getResult( ) (step A-22)

The getResult( ) method returns the result of the method called on MessagingHomeInterface or MessagingRemoteInterface. In the case of a call on a MessagingHomelnterface, the MessagingRemoteInterface is returned as a result and in the case of a call on a MessagingRemoteInterface, the intended result is returned. In the case of an exception occurring, the exception is returned as the result value. For example, if the user had called a create( ) method on the MessagingAccountHomelnterface, the getResult( ) will return an instance of the MessagingAccountRemoteInterface object. The user can then add an event listener using the method addlistener() to this MessagingAccountRemotelnterface again and call any business method asynchronously.

2. Bean side implementation

To deploy any bean in any implementation of the interface of the present invention, there are no restrictions on the bean developer. Any EJB compliant bean can be deployed when implementing the interface of the present invention.

3. API Reference—Asynchronous Interface and Class

The following interfaces and class are used by the client applications:

package client.messaging

Interfaces

public interface VandaMessagingEventListener

The above interface may be implemented by the client system, i.e., the client program. There may be occasions when a bean may call another bean asynchronously. In such cases the following interface is implemented by the calling bean. This interface defines the methods that allow the client to receive and process the result. The method is:

public void methodCompleted (VandaMessagingEvent resEvent)

The above method is called by the client side library to inform the client program that the result of a particular call has arrived.

public void exceptionOccurred(VandaMessagingEvent resEvent)

The above method is called by the client side library to inform the client program that the particular call has caused an exception.

Classes

public class VandaMessagingEvent

The above class is passed as an argument to the methodCompleted and exceptionOccurred methods of the VandaMessagingEventListener object. This class provides the calls to receive and process the result. The public method in this class is:

public Object getsource( )

The above method returns the source of the event in the string from classname:methodname.

public long getCallID( )

The above method returns the CallID associated with the call for which the result has arrived, i.e., the call that has caused this event.

public Object getResult( ) throws Exception

The above method returns the result of the method called previously (identified by CallID) or it triggers an exception in the event an exception occurred while executing the method. In the case of an exceptionOccurred in the VandaMessagingListener class, an exception may be triggered; however, an exception is generally not triggered by the methodCompletedo method.

4. Example

The following code defines an Account Bean:

public class AccountBean implements EntityBean {

public void ejbCreate(String accountId, double

initialBalance, String type)

{
}
public double getBalance ( )
{

return balance;

}

}

To create an account asynchronously using Account Bean, the create( ) method on Account Bean accepts three parameters—Name, Type of Account and Amount. The method is executed and depending on the outcome either the exceptionOccurred or the methodCompleted method is called. The following client-side code results in an asynchronous invocation on the Account Bean.

public class MyClient implements

VandaMessagingEventListener {

public myClass ( ) {

InitialContext ctx = new InitialContext ( );
AsyncMessagingAccountHomeInterface ref =

(AsyncMessagingAccountHomeInterface) ctx.lookup

(“vms://AccountHomeInterface”);

//Add listener to this reference
ref.addListener (this);
//create( ) method of Account Bean accepts three parameters Name,
Type of account and Amount
createID = ref.create (“Michael”, “C/A”, 1000);
}

public void methodCompleted (VandaMessagingEvent event) {

if (event.getCallID == createID) {

System.out.println (“record created”); // method was successful
try {

remoteObject = (AsyncMessagingAccountRemoteInterface)

event.getResult( );

}
catch (Exception e) {

e.printStackTrace ( );

}

}

}
public void exceptionOccurred (VandaMessagingEvent event) {

if(event.getCallID ( ) == createID) {// Exception occurred?

System.out.println (“exception creating account”);

try {

remote = (AsyncMessagingAccountRemoteInterface)

event.getResult ( );

}
catch (Exception e) {

// getResult throws an error that can be handled accordingly
system.out.println (“Exception Occurred;” - e.getMessage ( ))
e.printStackTrace ( );

}

}

}
public static void main (String [ ] args) {

MyClass my = new MyClass ( );
/* do something else */

}
//private variables
private long createID;
private AsyncMessagingAccountRemoteInterface remoteObject;
}

Implementing the Interface To Achieve Asynchronous Method Invocations

The present invention provides an interface that can be used with commercially available servers to achieve asynchronous method invocations at the container level. One method of implementing the interface of the present invention to achieve asynchronous method invocations entails the following steps:

1. Implement the server side communication protocol using an underlying messaging service like Oracle AQ, IBM MQ Series, JMS Implementations, etc.

2. Implement communication between client system and server using a client side library and the services of a messaging service like Oracle AQ, IBM MQ Series, JMS Implementations, etc.

3. Transparently generate asynchronous and synchronous implementations at the time of deployment of the bean in the implementation.

The foregoing detailed description of the present invention is provided for the purposes of illustration and is not intended to be exhaustive or to limit the invention to the precise embodiment disclosed. Accordingly, the scope of the present invention is defined by the following claims.

What is claimed is:

1. A method of implementing an interface to achieve asynchronous method invocations between a client system, a messaging server, and an enterprise JavaBeans-enabled server, comprising:
performing a lookup operation for an asynchronous home interface on Java naming and directory interface service;
returning a reference to the asynchronous home interface of an enterprise bean, to the client system;
making a call on the reference;
providing a listener for the asynchronous home interface to monitor a plurality of events;
generating an event;
receiving a result after generating the event; and
executing a method of the listener.

2. A method as defined in claim 1, further comprising making a call on a remote interface that returns a return identifier.

3. A method as defined in claim 2, wherein the return identifier of the call on the remote interface is a call identifier having a long value to uniquely identify the asynchronous method invoked.

4. A method as defined in claim 3, wherein the call identifier is used to retrieve an actual value returned from an asynchronous call.

5. A method as defined in claim 1, wherein the reference enables the client system to make asynchronous calls without a user having to write any messaging calls.

6. A method as defined in claim 1, further comprising converting the call on the reference to messaging objects using a client library of the client system.

7. A method as defined in claim 6, wherein the messaging objects are used for inserting messages into and retrieving messages from the messaging server.

8. A method as defined in claim 6, further comprising registering the listener with the client library for event notification.

9. A method as defined in claim 1, wherein the listener enables the client system to receive results from the call on the reference.

10. A method as defined in claim 1, further comprising generating asynchronous stubs using the reference.

11. A method as defined in claim 1, wherein executing the method of the listener produces a method return where the method return is selected from a group consisting of the return identifier, a source of the event, and a result of making the call on the reference.

12. A method of providing an interface for achieving asynchronous method invocations between a client system and an enterprise JavaBeans-enabled server, comprising:
performing a lookup operation for a home interface on an enterprise JavaBean that enables the client system to obtain a reference to the home interface;
providing a listener for the home interface to monitor events;
invoking a call to the home interface;
receiving a result when an event has occurred;
receiving a call identifier from the home interface; and
using the call identifier to identify the result of an asynchronous call.

13. A method as defined in claim 12, further comprising transmitting a call to the enterprise JavaBean.

14. An enterprise JavaBeans architecture configured to provide asynchronous method invocations, comprising:
a client system having a listener configured to generate a notification when an incoming message is detected and to generate an event when the incoming message has arrived;
a messaging server configured to communicate with the client system; and
an enterprise JavaBeans-enabled server having an interface configured to enable the listener to detect the incoming message being transmitted from the enterprise JavaBeans-enabled server, wherein the enterprise JavaBeans-enabled server is configured to communicate with the messaging server.

15. An enterprise JavaBeans architecture as defined in claim 14, wherein the result is in the form of an object.

16. An enterprise JavaBeans architecture as defined in claim 14, wherein the object is a VandaMessagingEvent object.

17. An enterprise JavaBeans architecture as defined in claim 14, wherein the interface is connected to the messaging server.

18. An enterprise JavaBeans architecture as defined in claim 14, wherein the client system includes a client contract that includes messaging calls, which enable the client system to asynchronously communicate with the enterprise JavaBeans-enabled server.
